(19) United States
(12) Patent Application Publication
(10) Pub. No.: US 2008/0284243 A1
(43) Pub. Date: Nov. 20, 2008

(54) Method for a Preventive-Action Protection System in a Motor Vehicle

(76) Inventors: Martin Auer, Ostelsheim (DE); Ludger Dragon, Herrenberg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/667,386

(22) PCT Filed: Nov. 10, 2004
(86) PCT No.: PCT/EP04/12685

§ 371 Date: Jul. 31, 2008

(51) Int. Cl. B60T 8/42

(52) U.S. Cl. 303/115.2

(57) ABSTRACT

In a method for operating a preventive-action protection system in a motor vehicle having safety devices for lessening the consequences of accidents, driving state data are monitored and with respect to a state of emergency braking. At least one of the safety devices is triggered if a state of emergency braking is determined and confirmed by a plausibility check. For the plausibility check, at least the control state of an antilock brake system and one of the brake pressure is monitored.

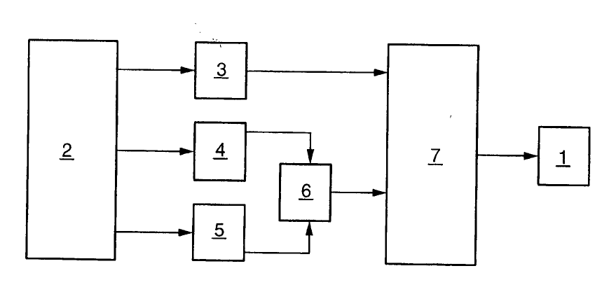

The invention relates to a method for a preventive-action protection system in a motor vehicle according to the preamble of patent claim 1.

Protection systems which are already active in a preventive fashion even before a possible collision and use what is referred to as a pre-crash phase, i.e. a period of time starting from the detection of a high probability of a collision by appropriate detection systems in the vehicle up to the actual impact, to enhance the vehicle occupant protection by means of additional safety measures and thus lessen the severity of an accident, are referred to as preventive-action protection systems or so-called PRE-SAFE™ systems. In order to detect possible accident situations, preventive-action protection systems make use of information which is made available by various sensor devices of the motor vehicle. The sensor devices here may also be a component of an electronic driving stability program and/or a component of an inter-vehicle distance sensor system. Depending on the detected situation, conclusions are drawn about a possible accident, and appropriate measures, relating to restraint systems for vehicle occupants and possibly protection devices for other parties in an accident, such as pedestrians, are initiated in order to condition the vehicle for the imminent accident.

Such a method for actuating a reversible vehicle occupant protection means in a motor vehicle is described by way of example in DE 101 21 386 C1. The motor vehicle here has a reversible vehicle occupant protection system which can be activated before a collision time and thus moved into an effective position. For this purpose, a sensor system is used to acquire driving state data which is monitored for any possible emergency braking, any possible oversteering and any possible understeering. If emergency braking, oversteering and/or understeering are detected, the vehicle occupant protection system is activated, in which case further conditions may be provided for the triggering operations. The sensor system for acquiring the driving state data can comprise a steering angle sensor, a pedal travel sensor, a brake pressure sensor, a wheel speed sensor, an acceleration sensor and a yaw rate sensor.

An emergency braking operation occurs if a braking process takes place with at least one feature which indicates a hazard situation or emergency situation. The state of emergency braking is determined by using at least one of the parameters of brake pressure, speed of the activation of the brake pedal and speed of the withdrawal of pressure from the accelerator pedal to evaluate the braking process. As an alternative to emergency braking which is brought about by the driver (driver reaction) it is possible to bring about emergency braking on the basis of sensing of the surroundings.

According to the document mentioned at the beginning, the state of emergency braking can be detected by means of an intervention by a brake assistance system in the vehicle movement dynamics by virtue of the fact that, for example, an information signal which is transmitted from the brake assistance system to a data bus is used to detect the state of emergency braking. Triggering of the safety devices of the protection system is then coupled to the algorithm of the brake assistance system. The signal of the brake light switch which is also made available on the data bus of the vehicle can also be used to confirm (check the plausibility of) the detection of the state of emergency braking. With this redundancy in the detection of an emergency braking operation, the reliability of a decision when the protection system is triggered is increased.

A further preventive-action protection system is disclosed in DE 100 29 061 A1. In order to detect a state of emergency braking, the time gradient, which corresponds to the derivation over time, of the brake pressure which is generated by the brake pedal is evaluated, in which case the fact that a threshold is exceeded by the brake pressure gradient is indicative of an emergency braking state. The pedal travel or the pedal force can also be measured as a representative of the measured brake pressure. In order to check the plausibility of the decision, the brake pressure is also submitted to evaluation in parallel to the brake pressure gradient by comparing the brake pressure with a brake pressure threshold value and comparing the time period when the threshold was exceeded by the measured brake pressure with a predefined time period. This is intended to separate out brief braking situations in which the brake pressure gradient is above the brake pressure gradient threshold but the braking request is not present for long enough with an intensity above the threshold.

In addition, according to DE 100 29 061 A1, the longitudinal deceleration (longitudinal braking measured value) of the vehicle and the state of an antilock brake system (ABS) are also monitored, in a separate decision channel, for the presence of a braking slip control process. A potential accident situation is detected if the longitudinal deceleration in the course of the braking slip control process exceeds a threshold value during a specific time.

The object of the invention is to specify an improved method for a preventive-action protection system of the type specified in the introduction.

This object is achieved with a method of the type mentioned at the beginning having the features of patent claim 1 or 5.

With the methods according to the invention it is possible to react better to real driving states by virtue of the fact that the detection of the state of emergency braking is better ensured.

The sensor system for sensing driving state data comprises, for example, a pedal travel sensor and/or a brake pressure sensor. With respect to the detection of the state of emergency braking, reference is made to DE 101 21 386 C1 and 100 29 061 A1 cited at the beginning. The state of emergency braking can thus be detected in an automated fashion either on the basis of driver reactions, for example on the basis of the brake pedal activation speed, the brake pressure gradient or triggering of a brake assistant, or on the basis of sensing of the surroundings.

In the embodiment according to patent claim 1, the locked state of the wheels or the control state of an antilock brake system is included in the plausibility checking of the state of emergency braking. It is thus possible to ensure that in the case of emergency braking on a slippery underlying surface on which the brake slip control process has to intervene, at least one safety device is activated independently of the fact that other plausibility check conditions are met.

In particular, the safety device can be activated independently of whether or not a brake pressure used to eliminate brief braking situations for plausibility checking indicates a critical state. When braking on a slippery underlying surface (low coefficient of friction) it is in fact possible for the antilock brake system (ABS) to control the brake pressure so early that the brake pressure is not a variable which is suitable for plausibility checking. If, for example, the measured pressure in the master brake cylinder is used for the brake pressure, said measured pressure is reduced early in an ABS control intervention so that overshooting of the threshold value, which would indicate plausibility, could never occur. If a pedal travel sensor is evaluated for the brake pressure, this signal is also possibly unusable in the ABS control intervention owing to the pulsating reaction on the brake pedal.

In one advantageous embodiment of the invention, plausibility checking is therefore carried out immediately on the state of emergency braking when a brake slip control process of the ABS starts. This ensures, for example, that despite inclusion of the brake pressure in the means of ensuring the detection of a state of emergency braking, the safety devices move into their protective position even in the case of full braking on a slippery underlying surface (low coefficient of friction).

Further embodiments refer to improved methods for checking the plausibility of the detection of the state of emergency braking by means of an evaluation of the brake pressure or of the brake pressure profile. These embodiments can also be used advantageously without the inclusion of the control state of an antilock brake system (ABS) as explained above.

These embodiments are recommended particularly if the detection of a state of emergency braking is based on an evaluation of the activation speed of the brake pedal. In this case it is in fact possible for high activation speeds to be reached owing to a delayed reaction of the back pressure in the brake system on the brake activation, as a result of the brake pedal being depressed rapidly and briefly, because it is not necessary to depress the brake pedal counter to a high resistance. This can lead to the detection of a state of emergency braking which however hardly decelerates the vehicle owing to the brief effective time (brief braking situation).

However, for this situation it is undesired to trigger a safety device, for example a reversible seatbelt pretensioner.

In one embodiment, the state of emergency braking is confirmed only if the brake pressure exceeds a brake pressure threshold. In this context the pressure in the master brake cylinder can be used as the brake pressure.

However, the plausibility check can also be carried out by means of a variable on which the brake pressure is based, for example the pedal travel or the pedal force, or by means of a brake pressure variable which is derived from the pedal travel or pedal force, for example using a characteristic curve or a suitable computational model of the brake system. Such a variable would be, for example, the requested braking torque.

In order to take into account the inertia of the brake system it is advantageous to define an evaluation time which is of the order of magnitude of the time at the pressure increase in the master brake cylinder (approximately 100 msec). Plausibility checking takes place only if the brake pressure exceeds the brake pressure threshold at the evaluation time. This ensures that safety devices are activated only if the requested brake pressure is sufficient to bring about deceleration of the vehicle which would move the vehicle occupants forward. Brief braking situations can be separated out through the level of the brake pressure threshold and through the selection of the evaluation time.

In order to acquire further precision, it is possible to require, as a further plausibility check condition, that the brake pressure profile must not have a negative gradient at the evaluation time, in order to separate out brake pressure profiles which are above the threshold value but have a negative gradient.

Basically, the brake pressure in the master brake cylinder can be used as an underlying measurement variable both for determining the state of emergency braking and for carrying out plausibility checking on it. However, the brake pressure in the master brake cylinder reacts extremely slowly to a sudden braking torque request by the driver and is therefore not very suitable for sensing the driver's request. In a conventional hydraulic brake system, a diaphragm travel sensor senses both the pedal movement and the diaphragm movement of the brake booster. The diaphragm travel sensor reacts much more directly to the pedal travel than does the brake pressure in the master brake cylinder. In an electrohydraulic brake system (brake-by-wire system) a pedal travel sensor picks up the activation of the brake pedal directly.

According to one development of the invention, which however can also be used advantageously without including the control state of an antilock brake system, the signal of a pedal travel sensor or diaphragm travel sensor is used to monitor the driving state data with respect to the state of emergency braking by virtue of the fact that the brake activation speed is determined, for example, from the derivation of a time. This has the advantage that the pedal travel at the beginning represents the driver's request directly and without faults. A reaction of the brake system on the pedal force does not occur until later in the course of the activation. A pedal travel measurement is therefore suitable for sensing the driver's request early. However, for plausibility checking by means of the brake pressure, the pressure in the master brake cylinder is a very suitable variable because it follows the brake pedal activation with a certain degree of inertia and thus many brief braking situations are already separated out because sufficient brake pressure is not generated.

In addition to the known restraining means which can be triggered preventively, such as the reversible seatbelt pretensioner of a seatbelt, there are a series of further vehicle occupant protection means which can be actuated and which generate a restraining effect or an energy-absorbing effect in order to protect a vehicle occupant in the event of a collision. Examples of such vehicle occupant protection means are movable impact elements, cushions and headrests whose size, hardness, shape and position can be changed by means of an actuation. In addition to these vehicle occupant protection means it is possible to provide further protection means which can be actuated in order to reduce the severity of an accident and which reduce the consequences of an accident for a vehicle occupant by actuating electrically adjustable assemblies, for example an electric seat adjustment device or an electric adjustment device for vehicle openings (window lifter, sunroof closing means) or door locking systems, which were originally provided for comfort purposes.

It is also possible to provide protection means in motor vehicles which can be actuated in order to lessen the consequences of accidents and which serve also to protect other parties to a collision, in particular to protect pedestrians and cyclists. Examples of this are adjustable engine hoods, movable bumpers and impact elements with adjustable hardness on the outer skin of the vehicle. Further protection means which can be actuated are the ride level control and the brake and steering system by means of which an impact can be optimized in the direction of less severe injury to the vehicle occupants and/or the other parties to the collision. These protection means are also to be understood below as safety devices within the sense of the present invention.

The single FIGURE shows by way of example a lock circuit diagram of a preventive-action protection system in a motor vehicle for carrying out an advantageous embodiment of the method according to the invention.

In order to actuate the preferably reversible safety devices 1, the driving state data which is picked up by means of the driving state sensor system 2 are monitored at least with respect to the state of emergency braking 3 by virtue of the fact that, for example, it is checked whether the signal of a brake pedal travel sensor indicates an activation speed above a threshold. In this case, the output of the stage 3 is set to logic “1”, and otherwise the output remains at logic “0”.

The brake pressure is evaluated in a brake pressure evaluation stage 4. If the brake pressure is above a brake pressure threshold, the output of this stage 4 is set to logic “1”, and otherwise it remains at “0”.

The antilock brake system (ABS) 5 outputs a logic “1” when a brake slip control process starts, and otherwise its output remains at “0”. In an equivalent fashion, the wheel speeds could also be directly monitored with respect to a locked state of the wheels and a “1” could be output when such a state is present.

In the logic stage 6, the output signals of the brake pressure evaluation stage 4 and of the antilock brake system 5 are fed to a logic OR linked.

In the plausibility checking stage 7, the output signal which indicates a state of emergency braking 3 and the output signal of the logic stage 6 are fed to a logic AND element.

As a result, one of the safety devices 1 triggers only if both a state of emergency braking 3 is indicated and the brake pressure exceeds a threshold or a control intervention is being made by the antilock brake system.

Instead of performing logic operations on the results of the various evaluations it is possible to bring about a comparable behavior of the protection system by providing a means of correspondingly influencing the triggering threshold or by forming an overall criticality which is dependent in a multifactorial fashion on the vehicle data and which assumes a value between 0 . . . 1 and has to overcome a fixed threshold at, for example, 0.8 for a safety device to be triggered.

1.-8. (canceled)

9. A method of operating a preventive-action protection system in a motor vehicle having safety devices for lessening the consequences of accidents, said method comprising:
a driving state sensor system acquiring driving state data;
monitoring said driving state data with respect to a state of emergency braking; and
triggering at least one of the safety devices if a state of emergency braking is determined and is confirmed by a plausibility check;
wherein existence of either of a locked state of vehicle wheels and a control state of an antilock brake system is included for the plausibility checking of the state of emergency braking.

10. The method as claimed in claim 9, wherein the sate of emergency braking is confirmed when locking of the wheels starts or brake slip control of the antilock brake system starts.

11. The method as claimed in claim 9, wherein brake pressure is also evaluated for plausibility checking of the state of emergency braking.

12. The method as claimed in claim 11, wherein the brake pressure must exceed a brake pressure threshold for the plausibility checking by means of the brake pressure.

13. The method as claimed in claim 12, for a preventive-action protection system in a motor vehicle having safety devices for lessening the consequences of accidents, wherein
driving state data are acquired by means of a driving state sensor system and are monitored with respect to a state of emergency braking;
at least one of the safety devices is triggered if a state of emergency braking is determined and is confirmed by a plausibility check; and
for plausibility checking of the state of emergency braking the brake pressure must exceed a brake pressure threshold; wherein the state of emergency braking is confirmed only if the brake pressure exceeds the brake pressure threshold at a specific evaluation time after the state of emergency braking has been determined.

14. The method as claimed in claim 13, wherein the state of emergency braking is confirmed only if the brake pressure profile does not have a negative gradient at the specific evaluation time.

15. The method as claimed in claim 11, wherein:
to evaluate the brake pressure, pressure in the master brake cylinder of the brake system is measured; and
to monitor driving state data with respect to the state of emergency braking, brake pedal travel is evaluated.

16. The method as claimed in claim 13, wherein:
to evaluate the brake pressure, pressure in the master brake cylinder of the brake system is measured; and
to monitor driving state data with respect to the state of emergency braking, brake pedal travel is evaluated.

17. The method as claimed in claim 15, brake pedal travel is measured by means of one of a pedal travel sensor and a diaphragm travel sensor.

18. The method as claimed in claim 17, brake pedal travel is measured by means of one of a pedal travel sensor and a diaphragm travel sensor.
